(19) United States
(12) Patent Application Publication
(10) Pub. No.: US 2006/0055514 A1
(43) Pub. Date: Mar. 16, 2006

(54) IC tag and IC-tag-attached sheet

(75) Inventors: Ryuichiro Maeyama, Ebina-shi (JP); Kenichi Kobayashi, Ebina-shi (JP); Tomoshi Hara, Minamiashigara-shi (JP); Kazuyuki Tsukamoto, Ashigarakami-gun (JP); Koji Morofuji, Ebina-shi (JP); Tsutomu Udaka, Ebina-shi (JP); Shinichi Tai, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/066,761

(22) Filed: Feb. 28, 2005

(30) Foreign Application Priority Data
Sep. 16, 2004 (JP) 2004-270458

(51) Int. Cl. H04Q 5/22

(52) U.S. Cl. 340/10.5

(57) ABSTRACT

An IC tag includes: a communication unit which exchanges data with an external device; a storing unit which stores data; a detecting unit which detects a change in environment surrounding the IC tag or a change in a state of the IC tag; and a deleting unit which deletes the data stored in the storing unit when the detecting unit detects a change in environment surrounding the IC tag or a change in a state of the IC tag.

This application claims priority under 35 U.S.C. §119 of Japanese Patent Application No. 2004-270458 filed on Sep. 16, 2004, the entire content of which is hereby incorporated by reference.

### BACKGROUND OF THE INVENTION

1. Field of the Invention

The present invention relates to a technique of processing data stored in an IC tag.

2. Description of the Related Art

Japanese Patent Application Laid-open Publication No. 2002-86862 discloses a technique of controlling an image forming apparatus depending on what type of a sheet for image formation is fed into the apparatus. The sheet has, for example, an attached IC tag in which attribute information of the sheet, such as the material, size, and thickness of the sheet, is written. The image forming apparatus pre-stores control parameters for each attribute of a sheet. Accordingly, upon reading attribute data of a sheet during formation of an image, the image forming apparatus reads control parameters corresponding to the attribute data, and, in accordance with the control parameters, conveys the sheet and forms an image thereon.

However, the technique has a problem that data written in an IC tag attached to a sheet can be corrupted by electrical noise generated in an image forming apparatus, while the sheet goes through the image forming apparatus. This is because an image forming apparatus of an electrophotographic type is composed of devices, such as a charging device, producing high voltages of electrostatic charge.

If an IC tag whose data has been corrupted is read by an image forming apparatus, the image forming apparatus operates on the basis of the corrupted data. Accordingly, there exists a problem that the image forming apparatus may not be able to operate in accordance with true attributes of a sheet, and conveyance of and image formation on the sheet may be adversely affected. Further, the image forming apparatus can even be caused to malfunction due to the corrupted data of the IC tag. The problem has become compounded in recent years due to the increasingly common practice of using the reverse side of a once-used sheet.

The present invention has been made with a view to addressing the above problems and provides a technique of, when data written in an IC tag is corrupted due to electrical noise, rendering the corrupted data unusable.

### SUMMARY OF THE INVENTION

To address the problems discussed above, the present invention provides an IC tag including: a communication unit which exchanges data with an external device; a storing unit which stores data; a detecting unit which detects a change in environment surrounding the IC tag or a change in a state of the IC tag; and a deleting unit which deletes the data stored in the storing unit when the detecting unit detects a change in environment surrounding the IC tag or a change in a state of the IC tag.

According to the IC tag, when a change in environment surrounding the IC tag or a change in a state of the IC tag is detected by a detecting unit, data stored in a storing unit is deleted.

### BRIEF DESCRIPTION OF THE DRAWINGS

An embodiment of the present invention will be described in detail with reference to the following figures, wherein:

FIG. 1 is a block diagram illustrating a configuration of IC tag 10 according to an embodiment of the present invention;

FIG. 2 is a block diagram illustrating a configuration of image forming apparatus 30 according to an embodiment of the present invention.

### DETAILED DESCRIPTION OF THE INVENTION

An Embodiment of the present invention will be described with reference to the drawings.

1. Embodiment

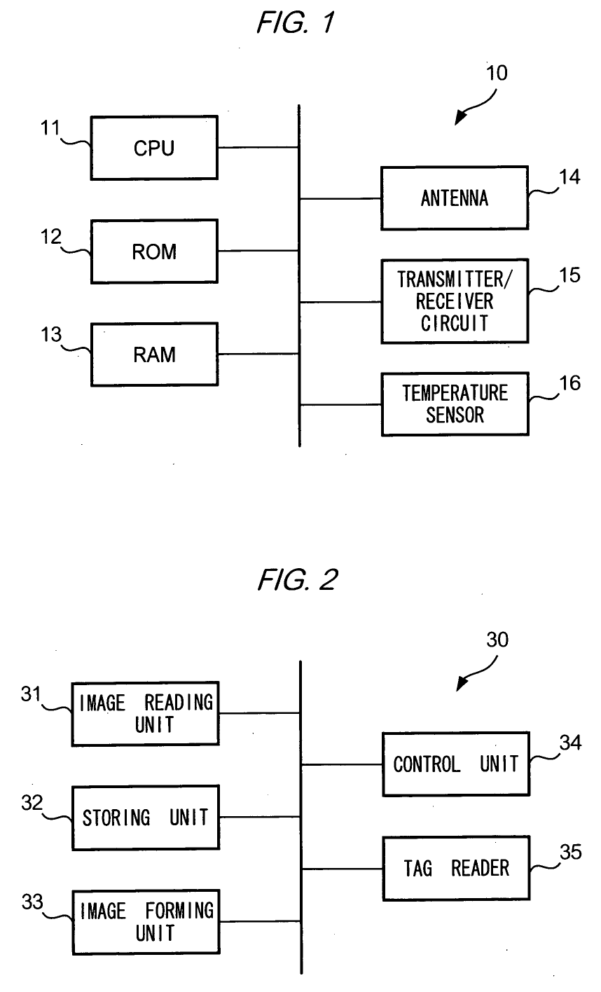

First, description will be made of a configuration of IC tag 10 with reference to FIG. 1.

FIG. 1 is a block diagram illustrating a configuration of IC tag 10. IC tag 10 is an RFID (Radio Frequency IDentification) tag which exchanges data with an external device in a non-contacting manner. IC tag 10 is attached to a sheet used for image formation.

ROM (Read Only Memory) 12 stores programs for controlling components of IC tag 10, and data of attributes of a sheet to which IC tag 10 is attached. The attribute data is, for example, information on the size, thickness, and type of the sheet.

Antenna 14 is for communicating with an external device (tag writer or tag reader) via microwave or induction field. Transmitter/receiver circuit 15 passes data between antenna 14 and CPU (Central Processing Unit) 11.

CPU 11, upon receiving a transfer request from a tag reader requesting transfer of data, reads and executes a program written in ROM 12 to read and transfer data written in ROM 12 to the tag reader. CPU 11, upon receiving data from a tag writer, writes the data in ROM 12. RAM 13 is used as a work area by CPU 11 when executing a program.

IC tag 10 further has temperature sensor 16 (detecting unit) for measuring the temperature surrounding IC tag 10, and which is connected to CPU 11. CPU 11 has an analog-digital conversion function for converting analog data from temperature sensor 16 to digital data.

Second, description will be made of a configuration of Image forming apparatus 30 with reference to FIG. 2.

FIG. 2 is a block diagram illustrating a configuration of image forming apparatus 30. This image forming apparatus 30 is a commonly known apparatus and does not constitute a feature of the present invention. Image reading unit 31 reads an image on a manuscript optically, to generate manuscript image data representing the image. Storing unit 32 temporarily stores manuscript image data generated by image reading unit 31. Image forming unit 33 has a function of forming an image on a surface of a sheet, e.g. in an electrophotographic manner. Image forming unit 33 forms an image on a surface of a sheet on the basis of manuscript image data read from storing unit 32. Image forming unit 33 is broadly composed of a charging unit, an exposing unit, a developing unit, a transferring unit, and a fixing unit (none of which are shown). Control unit 34 is broadly composed of a CPU, an RPM, and RAM, and controls operations of components of image forming apparatus 30.

Image forming apparatus 30 further includes tag reader 35. Storing unit 32 stores control parameters in association with each attribute of a sheet. The control parameters are for controlling conveyance of a sheet or image formation. The control parameter for controlling conveyance of a sheet is, for example, used for controlling a contact load and a torque of a roller feeding a sheet from a paper feed tray in accordance with the thickness and material of the sheet. The control parameter for controlling image formation is, for example, used for controlling a transfer pressure and a fixation temperature of a toner image in accordance with roughness and material of a sheet surface.

Control unit 34 causes tag reader 35 to read attribute data written in an IC tag attached to a sheet, and reads a control parameter corresponding to the read attribute data from storing unit 32. Control unit 34 controls, on the basis of the control parameter, components of image forming apparatus 30. Consequently, image forming apparatus 30 can control sheet conveyance and image formation appropriate to the attributes of the sheet.

Finally, description will be made of a technique of, when data written in an IC tag is corrupted due to electrical noise, rendering the corrupted data unusable.

Inside an image forming apparatus, the temperature is higher than the surrounding temperature. This is particularly the case for a transferring unit which transfers a toner image onto a sheet and a fixing unit which fixes a toner image transferred onto a sheet. This means that, if the temperature surrounding an IC tag is considered, it can be determined whether a sheet has gone through an image forming apparatus.

IC tag 10 according to the present embodiment has temperature sensor 16 therein. Accordingly, by measuring the temperature surrounding IC tag 10 with temperature sensor 16, it can be determined in IC tag 10 whether it has gone through an image forming apparatus. Specifically, in CPU 11 of IC tag 10, if the temperature surrounding IC tag 10 measured by temperature sensor 16 reaches a predetermined value, it is determined that it has gone through an image forming apparatus, and data written in ROM 12 is deleted. Thereby, corrupted data in ROM 12 of IC tag 10 can be removed. It is to be noted that the predetermined value is the temperature inside an image forming apparatus, which is set in advance.

2. Modifications

The above embodiment according to the present invention may be modified as follows:

Instead of deleting data written in ROM 12 of IC tag 10, transmitter/receiver circuit 15 or ROM 12 may be disabled. Among methods therefore is a method of disconnecting transmitter/receiver circuit 15 or ROM 12 from CPU 11.

A thermistor may be used instead of temperature sensor 16.

An electric potential sensor may be used instead of temperature sensor 16. Since devices are available which produce high voltages of electrostatic charge such as a charging device in an image forming device, by measuring the electric potential by the electric potential sensor, it can be determined whether a sheet has gone through the image forming apparatus. In this case, the electric potential sensor measures the electric potential, and when the measured electric potential reaches a predetermined value, data written in ROM 12 of IC tag 10 is deleted, or transmitter/receiver circuit 15 or ROM 12 is disabled.

A load sensor for measuring a load on a sheet may be used instead of temperature sensor 16. A sheet, while going through an image forming apparatus, receives pressure from nip units provided on a paper feed unit, a sheet transport path, or a fixing unit. Accordingly, by measuring the load on a sheet by the load sensor, it can be determined whether a sheet has gone through the image forming apparatus. In this case, the load sensor measures the load on a sheet, and when the measured load reaches a predetermined value, data written in ROM 12 of IC tag 10 is deleted, or transmitter/receiver circuit 15 or ROM 12 is disabled.

An acceleration sensor for measuring acceleration of a sheet may be used instead of temperature sensor 16. Since a sheet is transported at high speed in an image forming apparatus after being fed from a paper feed unit, by measuring acceleration of a sheet by the acceleration sensor, it can be determined whether a sheet has gone through the image forming apparatus. In this case, the acceleration sensor measures acceleration of a sheet, and when the measured acceleration reaches a predetermined value, data written in ROM 12 of IC tag 10 is deleted, or transmitter/receiver circuit 15 or ROM 12 is disabled. The acceleration sensor may measure acceleration of a sheet on the basis of GPS (Global Positioning System) signals transmitted from GPS satellites.

As described above, the present invention provides an IC tag including: a communication unit which exchanges data with an external device; a storing unit which stores data; a detecting unit which detects a change in environment surrounding the IC tag or a change in a state of the IC tag; and a deleting unit which deletes the data stored in the storing unit when the detecting unit detects a change in environment surrounding the IC tag or a change in a state of the IC tag.

According to the IC tag, when a change in environment surrounding the IC tag or a change in a state of the IC tag is detected by a detecting unit, data stored in a storing unit is deleted.

Also, the present invention provides an IC tag including: a communication unit which exchanges data with an external device; a storing unit which stores data; a detecting unit which detects a change in environment surrounding the IC tag or a change in a state of the IC tag; and a disenabling unit which disenables the communication unit or the storing unit when the detecting unit detects a change in environment surrounding the IC tag or a change in a state of the IC tag.

According to the IC tag, when a change in environment surrounding the IC tag or a change in a state of the IC tag is detected by a detecting unit, a communication unit or a storing unit is disabled.

Also, the present invention provides an IC-tag-attached sheet to which any one of the above IC tags is attached.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical application, to thereby enable others skilled in the art to understand other embodiments or modifications which can be applied to the particular use contemplated. It is intended that the scope of the invention be defined by the following claims and their equivalents.

What is claimed is:

1. An IC tag comprising:
a communication unit which exchanges data with an external device;
a storing unit which stores data;
a detecting unit which detects a change in environment surrounding the IC tag or a change in a state of the IC tag; and
a deleting unit which deletes the data stored in the storing unit when the detecting unit detects a change in environment surrounding the IC tag or a change in a state of the IC tag.

2. An IC tag comprising:
a communication unit which exchanges data with an external device;
a storing unit which stores data;
a detecting unit which detects a change in environment surrounding the IC tag or a change in a state of the IC tag; and
a disenabling unit which disenables the communication unit or the storing unit when the detecting unit detects a change in environment surrounding the IC tag or a change in a state of the IC tag.

3. An IC tag according to claim 1, wherein:
the detecting unit measures a temperature or an electric potential; and
the deleting unit deletes the data stored in the storing unit when the temperature or the electric potential measured by the detecting unit reaches a predetermined value.

4. An IC tag according to claim 2, wherein:
the detecting unit measures a temperature or an electric potential; and
the disenabling unit disenables the communication unit or the storing unit when the temperature or the electric potential measured by the detecting unit reaches a predetermined value.

5. An IC-tag-attached sheet, wherein
the IC tag comprises:
a communication unit which exchanges data with an external device;
a storing unit which stores data;
a detecting unit which detects a change in environment surrounding the IC tag or a change in a state of the IC tag; and
a deleting unit which deletes the data stored in the storing unit when the detecting unit detects a change in environment surrounding the IC tag or a change in a state of the IC tag.

6. An IC-tag-attached sheet, wherein
the IC tag comprises:
a communication unit which exchanges data with an external device;
a storing unit which stores data;
a detecting unit which detects a change in environment surrounding the IC tag or a change in a state of the IC tag; and
a disenabling unit which disenables the communication unit or the storing unit when the detecting unit detects a change in environment surrounding the IC tag or a change in a state of the IC tag.
